(19) United States
(12) Patent Application Publication
(10) Pub. No.: US 2012/0223860 A1
(43) Pub. Date: Sep. 6, 2012

(54) Use of Motion or Accelerometer Sensors in Low Power Positioning System

(75) Inventor: Maxime Leclercq, Encinitas, CA (US)

(73) Assignee: MaxLinear, Inc., Carlsbad, CA (US)

(21) Appl. No.: 13/218,985

(22) Filed: Aug. 26, 2011

Related U.S. Application Data
(60) Provisional application No. 61/377,436, filed on Aug. 26, 2010.

(51) Int. Cl. G01S 19/34; G01S 19/24

(52) U.S. Cl. 342/357.63; 342/357.74

(57) ABSTRACT

A power-saving GNSS includes a sensor for detecting a motion of the receiver, an RF front-end for receiving satellite signals, and a central processing unit coupled to the front-end for acquiring a set of the received satellite signals if the motion is detected. The receiver further include a signal strength evaluator for evaluating a signal strength of the acquired set of the received signals and a counter to count a time period for which the signal strength is below a predetermined value. The receiver also includes a control unit for setting the receiver into an intermittent operating mode if the signal strength exceeds the predetermined value sets the receiver into a power-saving mode if the signal strength is below the predetermined value for the time period determined by the counter. The receiver may also be set into the power-saving mode if it remains stationary for a given time interval.

### CROSS-REFERENCES TO RELATED APPLICATIONS

The present application claims benefit under 35 USC 119(e) of U.S. provisional application No. 61/377,436, filed Aug. 26, 2010, entitled “Use of Motion or Accelerometer Sensors in Low Power Positioning System”, the content of which is incorporated herein by reference in its entirety.

The present application is related to and herein incorporates by reference the entire contents of application Ser. No. 13/218,383, filed Aug. 25, 2011; and application Ser. No. 61/377,425, filed Aug. 26, 2010.

### BACKGROUND OF THE INVENTION

Embodiments of the present invention relate to a global navigation satellite systems (GNSS) device, and more particular, to a power-saving GNSS device.

Many commercial GNSS receivers are designed to be handheld, i.e., they can be carried by a user. In general, the user may not have access to an external power source to recharge the GNSS receiver. In order to extend the operation of the receiver, known power savings techniques resort to putting the receiver in a standby mode or sleep mode when the receiver is not in use. One technique is that the user manually switch off the receiver when it is not in use. Although this technique provides efficient power savings, it is, in general, not practical as the power-on time and the acquisition of the location information of the receiver will be unacceptably long. Because a GNSS receiver is intended to be used on a continuous basis, the receiver must kept ephemeris, received signal strengths of satellites, and other information in a standby state. A conventional power savings method is to power on a GNSS receiver during known time intervals to perform tracking operations or acquisitions during those intervals. This allows the receiver to sleep (or go into a power saving mode) for a limited time and then wake-up at fixed intervals to calculate its position. Conventional receivers thus have predictable sleep patterns, i.e., their sleep periods are pre-calculated given a rate of update or system calibration.

While users of handheld GNSS receivers appreciate the increase in battery life obtained by this method, they still expect to obtain even longer battery life if the GNSS devices can set themselves to a sleep mode to further conserve power. It is therefore desired to have techniques for a GNSS deice to set itself to different operating modes in order to reduce power usage.

### BRIEF SUMMARY OF THE INVENTION

In accordance with embodiments of the present invention, a power-savings GNSS receiver has at least three power-efficient modes that the receiver can switch into without any user's invention. In an embodiment, the power-savings GNSS receiver includes a radio frequency front-end coupled to an antenna for acquiring signals from various satellites and frequency-converting them to an intermediate frequency or a baseband signal. The receiver also includes a central processing unit for processing the baseband signal to obtain a position, velocity, and time (PVT fix) information and a display unit to provide the information to a user. The receiver may include a memory unit for storing the obtained PVT information. The receiver may further include a sensor for detecting a motion of the receiver, a counter for determining a time interval and a control unit for setting the receiver into one of the three power-efficient operation modes. In an embodiment, the sensor may be one of an accelerometer, a vibration sensor, an inertial sensor, a digital compass, and the like.

According to embodiments of the present invention, a power-saving GNSS includes a sensor for detecting a motion of the receiver, an RF front end for receiving satellite signals, and a central processing unit coupled to the front-end for acquiring a set of the received satellite signals if the motion of the receiver is detected. In an embodiment, the receiver may include a signal strength evaluator for evaluating a signal strength of the acquired set of the received signals and a counter to count a time period for which the signal strength is below a predetermined value. In an embodiment, the receiver also include a control unit for setting the receiver into an intermittent operating mode if the signal strength exceeds the predetermined value. The control unit sets the receiver into a power-saving mode if the signal strength is below the predetermined value for the time period determined by the counter. The control unit may also set the receiver into the power-saving mode if the receiver remains stationary, i.e., no motion is detected, for a given time interval.

In an embodiment, a power-saving receiver includes an RF front-end for receiving satellite signals, a central processing unit for determining a receive signal strength in an intermittent time interval, and a control unit for setting the receiver in a power-saving mode when the signal strength is below a threshold for a consecutive number of intermittent intervals. In an embodiment, the receiver further include a counter for counting a number of time units, and a motion sensor for detecting whether the receiver has moved within the number of time units. If there is no motion of the receiver with the number of time units, the control unit sets the receiver into the power-saving mode to conserve power.

Embodiments of the present invention also disclose a method for operating a power-saving GNSS receiver. The method includes detecting a motion of the receiver, and acquiring a satellite signal and determining a parameter of the signal in the event that the motion is detected. The method further includes setting the receiver in an intermittent operating mode if the parameter exceeds a predetermined value and setting the receiver in a power-saving mode if the parameter does not exceed the predetermined value. In an embodiment, the parameter may be a signal strength of the acquired satellite signal. In another embodiment, the parameter may be a bit error rate of a demodulated signal. In yet another embodiment, the parameter may include a position error.

In another embodiment, a method for operating a power-saving GNSS receiver includes acquiring a satellite signal, determining a parameter of the intermittently acquired signal, and setting the receiver in a power-saving mode if the parameter is below a predetermined value. In an embodiment, the parameter may be a signal strength of the acquired satellite signal.

### BRIEF DESCRIPTION OF THE DRAWINGS

Preferred embodiments of the present invention are described below, by way of example, with reference to the accompanying drawings, in which:

FIG. 1 is a block diagram illustrating a GNSS receiver according to an embodiment of the present invention;

FIG. 2 is a state diagram of a GNSS receiver according to an embodiment of the present invention; and

FIG. 3 is a flowchart diagram of a power-saving method 300 according to an embodiment of the invention.

### DETAILED DESCRIPTION OF THE INVENTION

The present invention provides apparatus and methods for using MEMs accelerometer sensors, gyroscope, digital compass, vibration sensors, or any other inertial sensors to optimize power saving in a positioning device such as digital cameras or camcorders. An application of the GPS in a camera is to provide position information to geotag a picture. The GPS receiver continues to track satellites in order to be ready with a position fix when the user takes a picture. This solution despite having the best response time, suffers from high power consumption because the receiver needs to continuously operate to monitor the sky and calculate position.

In accordance with embodiments of the present invention, a GNSS receiver is powered down into a sleep state or an intermittent mode of operation when it detects no motion (interpreted as the camera is, for example, resting on a shelf or being stored). The GNSS receiver is awakened when it detects a motion, anticipating that the user plans to take a picture.

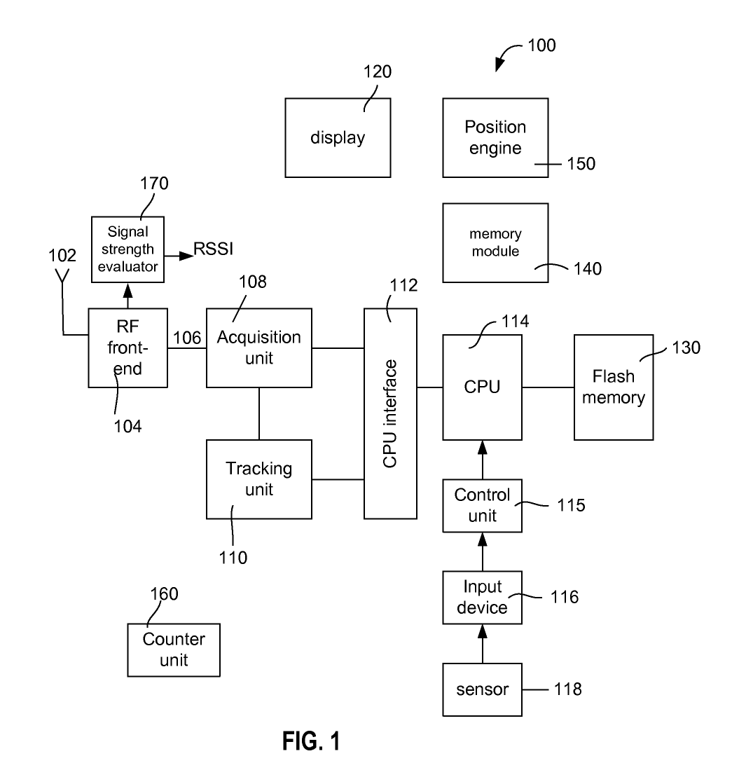

FIG. 1 is a block diagram illustrating a GNSS receiver 100 according to an embodiment of the present invention. Receiver 100 includes an antenna 102 for receiving GNSS satellite signals, a radio frequency (RF) front end 104 coupled to the antenna 102 for frequency converting the received signals to an intermediate frequency or a baseband signal 106. Baseband signal 106 is provided to an acquisition unit 108 and a tracking unit 110 that provide the tracked and acquired satellite signals to a CPU 114 via a CPU interface unit 112 for demodulation. The GNSS receiver calculates its position, velocity, and time information from the demodulated signals. The receiver measures its velocity with respect to that of a satellite by measuring the Doppler shift of the signals received from the satellite. Using an ephemeris and almanac, the position of the satellite are precisely known. The receiver can also determine its travel direction by interpolating its last known position. However, the position, velocity and time information determined by the receiver may not always be available due to coverage gap caused by loss of sight of the satellites when the receiver enters a building, a tunnel, or in dense urban areas.

The GNSS receiver also includes an input device 116 for receiving input data provided by a user or by a sensor 118. Sensor 118 can be, for example, an accelerometer, a motion detector, a compass, a vibration sensor, an altimeter, and the like. In an embodiment, the receiver may include a control unit 115 that is capable of accept a signal coming from the sensor and issue one or more control signals to set the receiver in different power-saving states as described in more detail below. The receiver includes an output device 120 for providing position information to a user. In an embodiment, output device 120 may be an LCD display for displaying position, velocity, and time information to a user. An optional flash memory 130 coupled to the CPU may provide instructions and data to operate the CPU including the acquisition and tracking units. In an embodiment, the execution program codes and data for the operation of the receiver may be stored in a ROM, EPROM, EEPROM, and the like that are embedded in the CPU. The tracking and acquisition units may track the codes and carriers of the received satellite signals and determine the pseudo range of the receiver to the satellites and the offset of the receiver's clock from the satellite time reference. The pseudo range measurements and navigation data from at least four satellites are used to compute a three dimensional position and velocity fix. The CPU computes together with the acquisition and tracking units and a position engine 150 C/A codes and tracking loops, pseudo range measurements, acquisition and storage of almanac and ephemeris data broadcasted by the satellites. The obtained data including the position and velocity of the receiver can be stored in registers embedded in the CPU or in a memory module 140.

A GNSS receiver may continuously acquire signals coming from GNSS satellites and then track them. Acquisition is computationally intensive and consumes the most power. Therefore, in an embodiment, the receiver may switch to an intermittent tracking mode once the satellite signals have been acquired.

In an embodiment, the GNSS receiver may include three states of power-saving operation. One state is an intermittent tracking operation state during which the receiver receives satellite information and calculates time and position (“PVT” Position Velocity and Time). The position (“PVT fix”) is reported to the user typically at fixed time intervals called the rate of update. The position fix may be stored by the receiver in embedded registers or in the memory module. The receiver include a counter unit 160 that can generates multiple time interval values. One of the time interval values can be a sleep interval value that, once expired, causes the receiver to start a new tracking operation and calculate a new position fix. In an embodiment, the receiver compares the previous stored position fix with the new position fix, and determines whether the receiver has changed its position between the two tracking operations. In an embodiment, if there is no change in position of the receiver is a given time period which can be determined by no significant difference between the stored position fix and the new position fix during the given time period, the receiver may switch to a park state which can be a sleep mode or a idle mode where many functional blocks of the receiver are powered off. In an exemplary embodiment, the RF front end, the acquisition and tracking units, the position engine, the display are powered off during the park state. A low-power motion sensor takes over the monitoring function of the receiver. In an embodiment, the low-power motion sensor may be an MEMS sensor that detects a movement of the receiver and provides an interrupt (wake-up) signal to the central processing unit.

While operating in the intermittent tracking state, if the signal strength of the acquired and tracked signals is weak and below a certain threshold value determined by a signal strength evaluator 170 , the receiver may assume that it has entered an area where the satellite coverage is insufficient or not present and switch from the intermittent tracking mode to an indoor mode. It should be noted that the indoor state is also entered when an position error is present determined, for example, by a number of bit errors in the demodulated signals or quality of the obtained position fix (e.g., unacceptable difference between the stored position fix and the new position fix). While in the indoor state, the receiver may try to determine a new position by going back to the intermittent tracking state.

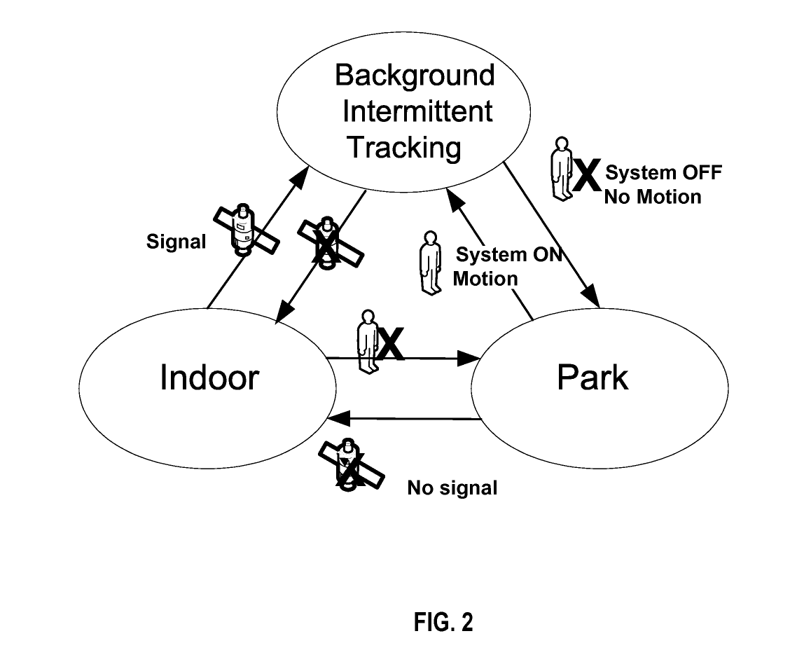

FIG. 2 shows a state diagram of a GNSS receiver in accordance with one embodiment of the present invention. As shown in FIG. 2, at any point in time, the GNSS receiver may be in one of three states, namely Background Intermittent state, Indoor state, or Park state. When in the Background Intermittent state, the GNSS receiver tracks satellites periodically to calculate and save PVT (position, velocity, and time) information. Accordingly, in this state, tracking and acquisition are carried out.

The GNSS receiver is in its lowest power consumption mode when it is in the Park state. In the Park state, the GNSS receiver decodes satellites only to keep its ephemeris data up to date or alternatively provide a hot start condition. This state is entered when the system is powered off or no motion is detected for a long period of time. The GNSS receiver exits this state when a motion is detected or the system is powered on. After exiting this state, the GNSS receiver immediately performs satellite signal acquisition to provide an accurate PVT fix.

The GNSS receiver enters the Indoor state during signal reception gaps or when a PVT fix cannot be calculated. In an embodiment, the GNSS receiver enters the Indoor state after a consecutive number of failed intermittent tracking attempts. The GNSS receivers continues to monitor the sky condition and attempts to periodically achieve acquisition while it is in the Indoor state.

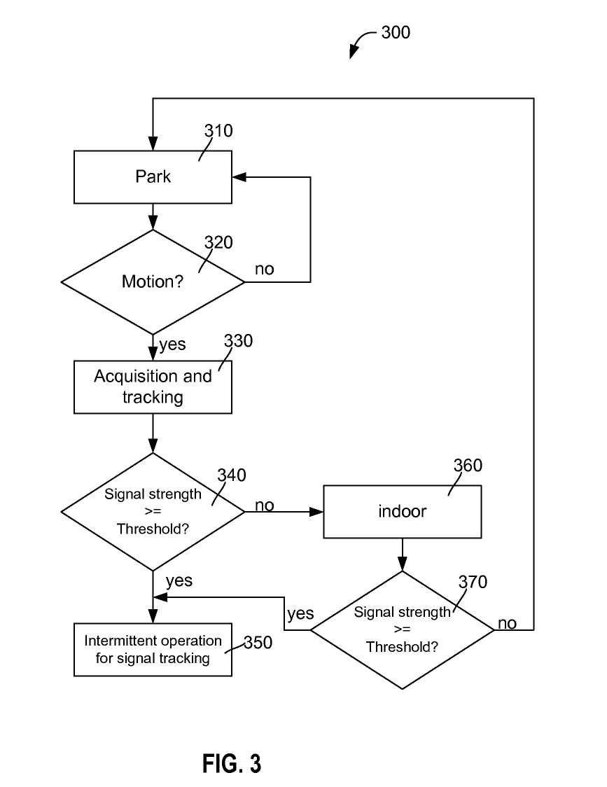

FIG. 3 is a flowchart diagram 300 of a power-saving method 300 according to an embodiment of the invention. In an exemplary embodiment, the receiver may be in a park state (step 310). For example, the receiver is powered off, and the sensor is actively monitoring a motion of the receiver. At step 320, if there is no motion, the receiver remains in the park state. However, if a motion is detected, a wake up signal is issued to the receiver to start the acquisition and tracking processing or a hot start at step 330 where a signal strength of the acquired and tracked signals is evaluated for a period of time (step 340). In an embodiment, the period of time is provided by the counter unit 160 as shown in FIG. 1. If the signal strength is over a threshold value, the receiver enters an intermittent operating mode to track satellite signals (step 350). However, if the signal strength is below the threshold value, the receiver enters an indoor state (step 360). In this state, the receiver may be in a dense urban area, inside a building, in a canyon where the signal reception is poor. In this state, the receiver attempts to acquire and track satellite signals. Once the signals are acquired and tracked, the receiver may enters the intermittent operation mode. If the acquired and tracked signal strength is below the threshold value or if the quality of demodulated signal is poor (e.g., high number of bit errors of the demodulated signal or incorrect position, velocity, and time information), the receiver is set to the park state, i.e., powered off to conserve power.

It should be noted that the step sequences shown in FIG. 3 are arbitrary. In another embodiment, the method may begin at step 330 where the receiver acquires and tracks signals from satellites. Following step 330 is step 340 where the signal strength of acquired signals is compared with a threshold value. Depending upon the result of the comparison, the receiver may enter the indoor state or the intermittent operating mode. In yet another embodiment, the method may begin at step 360 where the receiver is in an indoor state. In this state, the receiver attempts to track satellite signals and enters the intermittent operating mode (step 350) or in the park state (step 310).

Therefore, the steps of the method described in connection with FIG. 3 may be perform in the order shown, or may be performed in another order. This fact can be clearly seen in FIG. 2 where there is no beginning or end. Additionally, one or more steps may be omitted or one or more steps may be added in the beginning, in the end, or in the intermediate steps. For example, steps for counting a number of consecutive intermittent time intervals where the signal strength or the quality of the demodulated signal is below a threshold value can be added prior to transitioning the receiver from one state to another state.

The embodiments of the present invention have been presented for the purposes of illustration and description. They are not intended to be restrictive. Many embodiments will be apparent to those of skill in the art upon reviewing the above description. The scope of the invention should, therefore, be determined not with reference to the above description, but instead should be determined with reference to the appended claims.

What is claimed is:

1. A power-saving GNSS receiver comprising:
a sensor for detecting a motion of the receiver;
a radio frequency (RF) front-end configured to receive satellite signals;
a central processing unit coupled to the RF front-end and configured to acquire a set of the received satellite signals in the event that the motion is detected.

2. The power-saving GNSS receiver of claim 1 further comprising:
a signal strength evaluator configured to evaluate a signal strength of the acquired set of the received satellite signals; and
a counter configured to count a time period for which the signal strength is below a threshold.

3. The power-saving GNSS receiver of claim 2 further comprising:
a control unit configured to set the receiver in an intermittent operating mode in the event that the signal strength exceeds or equals the threshold during the time period and sets the receiver in a power-saving mode in the event that the signal strength is below the threshold during the time period.

4. The power-saving GNSS receiver of claim 1, wherein the sensor is one of an MEMS accelerometer sensor, a gyroscope, a digital compass, a vibration sensor, or an inertial sensor.

5. A power-saving GNSS receiver comprising:.
a radio frequency (RF) front-end configured to receive satellite signals;
a central processing unit coupled to the RF front-end and configured to determine a receive signal strength indication (RSSI) signal from the received satellite signals in an intermittently active interval; and
a control unit configured to set the receiver in a power-saving mode in the event that the RSSI signal is below a threshold for a consecutive number of intermittently active intervals.

6. The power-saving GNSS receiver of claim 5 further comprising:
a counter configured to count a number of time units; and
a sensor coupled to the central processing unit and configured to detect a motion of the receiver, wherein the control unit sets the receiver in the power-saving mode in the event that a motion of the receiver is not detected within the number of time units.

7. The power-saving GNSS receiver of claim 6, wherein the sensor is one of an MEMS accelerometer sensor, a gyroscope, a digital compass, a vibration sensor, or an inertial sensor.

8. A method for operating a power-saving GNSS receiver, the method comprising:
detecting a motion of the receiver;
in the event that the motion is detected:
acquiring a signal from at least a satellite; and
determining a parameter of the acquired satellite signal; and
in the event that the parameter exceeds a predetermined value:
setting the receiver in an intermittent operating mode;
in the event that the parameter does not exceed the predetermined value:
setting the receiver in a power-saving mode.

9. The method of claim 8, wherein the parameter is determined within a predetermined time period.

10. The method of claim 8, wherein the parameter comprises a signal strength of the acquired signal.

11. The method of claim 8, wherein the parameter comprises a bit error rate of a demodulated signal.

12. The method of claim 8, wherein the parameter comprises a position error.

13. A method for operating a power-saving GNSS receiver, the method comprising:
acquiring a signal from a satellite in an intermittent time interval;
determining a parameter of the acquired signal;
setting the receiver in a power-saving mode if the parameter is below a predetermined value for a consecutive number of intermittent time intervals.

14. The method of claim 13, the parameter comprises a signal strength of the acquired signal.
